(19) United States
(12) Patent Application Publication
(10) Pub. No.: US 2006/0039334 A1
(43) Pub. Date: Feb. 23, 2006

(54) Wireless network communication control apparatus and network system

(76) Inventor: Kifumi Koga, Kawasaki (JP)

Correspondence Address: KATTEN MUCHIN ROSENMAN LLP, 575 MADISON AVENUE, NEW YORK, NY, 10022-2585, US

(21) Appl. No.: 10/998,022

(22) Filed: Nov. 24, 2004

(30) Foreign Application Priority Data
Aug. 19, 2004 (JP) 2004-239373

(51) Int. Cl. H04Q 7/24

(52) U.S. Cl. 370/338

(57) ABSTRACT

A wireless network communication control apparatus and a network system wherein wireless network client connection control information with identical contents can be set in a simple manner and at low cost in a plurality of wireless network communication control apparatuses (wireless LAN access points). A parent LAN access point prestores the MAC addresses of wireless LAN clients as the wireless LAN client connection control information to be managed therein. A child access point stores the IP address of the parent access point and, based on the IP address, transmits an inquiry packet to the parent access point at predetermined intervals of time. When the inquiry packet is received, the parent access point transmits to the child access point a reply packet containing the MAC addresses of the wireless LAN clients that the parent access point has prestored. The child access point receives the reply packet, and stores the MAC addresses contained therein as its own connection control information.

### BACKGROUND OF THE INVENTION

1. Field of the Invention

The present invention relates to a wireless network communication control apparatus which performs connection control of wireless network clients by using their first classification addresses, and also relates to a network system containing such a wireless network communication control apparatus.

2. Description of the Related Art

In recent years, wireless LANs (Local Area Networks) have been spreading widely, with their data rates, costs, compatibility, etc. reaching the levels equivalent to those of wired LANs. While wireless LANs, which eliminate the need for wired connections, offer several advantages such as increased freedom in the installation of terminals and increased flexibility in operation, the lack of physical connections inherently gives rise to the problem of unauthorized access to the networks through unauthenticated connections. It is therefore extremely important that wireless LAN clients allowed to connect to a wireless LAN access point be limited. A wireless LAN access point is an apparatus that comprises a wireless LAN interface and a wired LAN interface, and has the function of relaying communications between wireless LAN terminals and also the function of relaying communications between a wireless LAN terminal and a wired LAN terminal.

From the security point of view, the above access control must be performed at every wireless LAN access point; for example, as disclosed in Japanese Unexamined Patent Publication No. 2003-235082, the control is performed using a MAC (Media Access Control) address which is a physical address unique to each network adapter.

At present, the setting for each particular wireless LAN access point is made on an individual basis using a WWW (World Wide Web) browser on a terminal's personal computer by accessing the HTTP (Hypertext Transfer Protocol) server that the apparatus has. Accordingly, when there are many access points that need setting, it takes a great deal of time and labor to make the settings. A method is available that uses administration software and a system for making the settings for a plurality of wireless LAN access points in a collective manner, but the administration of such a system is extremely costly.

### SUMMARY OF THE INVENTION

The present invention has been devised in view of the above problem, and an object of the invention is to provide a wireless network communication control apparatus and a network system wherein wireless network client connection control information with identical contents can be set in a simple manner and at low cost in a plurality of wireless network communication control apparatuses.

To achieve the above object, according to a first aspect of the present invention, there is provided a network system containing a plurality of wireless network communication control apparatuses which perform connection control of wireless network clients by using the first classification addresses thereof, wherein at least one of the wireless network communication control apparatuses comprises: a first classification address storing unit which stores the first classification addresses of the wireless network clients as its own connection control information; an inquiry data receiving unit which receives inquiry data transmitted from another one of the wireless network communication control apparatuses connected via a network; and a reply data transmitting unit which transmits reply data containing the first classification addresses of the wireless network clients retrieved from the first classification address storing unit, to that other wireless network communication control apparatus in response to the inquiry data received by the inquiry data receiving unit, and wherein that other wireless network communication control apparatus comprises: a first classification address storing unit which stores the first classification addresses of the wireless network clients as its own connection control information; a second classification address storing unit which stores the second classification address of a particular one of the wireless network communication control apparatuses connected via the network; an inquiry data transmitting unit which, based on the second classification address stored in the second classification address storing unit, transmits the inquiry data to the particular wireless network communication control apparatus at predetermined intervals of time; and a reply data receiving unit which receives the reply data transmitted from the particular wireless network communication control apparatus that received the inquiry data transmitted by the inquiry data transmitting unit, and which stores in the first classification address storing unit the first classification addresses of the wireless network clients contained in the reply data.

According to a second aspect of the present invention, preferably, the inquiry data transmitting unit in the network system according to the first aspect of the present invention transmits the inquiry data by including therein information indicating the time and date of reception of previous reply data, and the reply data transmitting unit compares the information contained in the inquiry data with the last update time and date of the connection control information managed therein, and does not transmit the reply data if the connection control information managed therein has not been updated since the time and date of reception of the previous reply data.

According to a third aspect of the present invention, there is provided a wireless network communication control apparatus which performs connection control of wireless network clients by using the first classification addresses thereof, comprising: a first classification address storing unit which stores the first classification addresses of the wireless network clients as its own connection control information; an inquiry data receiving unit which receives inquiry data transmitted from another wireless network communication control apparatus connected via a network; a reply data transmitting unit which transmits reply data containing the first classification addresses of the wireless network clients retrieved from the first classification address storing unit, to that other wireless network communication control apparatus in response to the inquiry data received by the inquiry data receiving unit; a second classification address storing unit which stores the second classification address of a particular wireless network communication control apparatus connected via the network; an inquiry data transmitting unit which, based on the second classification address stored in the second classification address storing unit, transmits inquiry data to the particular wireless network communication control apparatus at predetermined intervals of time; and a reply data receiving unit which receives reply data transmitted from the particular wireless network communication control apparatus that received the inquiry data transmitted by the inquiry data transmitting unit, and which stores in the first classification address storing unit the first classification addresses of the wireless network clients contained in the reply data.

According to a fourth aspect of the present invention, there is provided a program executable on a wireless network communication control apparatus that performs connection control of wireless network clients by using first classification addresses thereof, wherein the program causes the wireless network communication control apparatus to implement the functions of: a first classification address storing unit which stores the first classification addresses of the wireless network clients as its own connection control information; an inquiry data receiving unit which receives inquiry data transmitted from another wireless network communication control apparatus connected via a network; a reply data transmitting unit which transmits reply data containing the first classification addresses of the wireless network clients retrieved from the first classification address storing unit, to that other wireless network communication control apparatus in response to the inquiry data received by the inquiry data receiving unit; a second classification address storing unit which stores the second classification address of a particular wireless network communication control apparatus connected via the network; an inquiry data transmitting unit which, based on the second classification address stored in the second classification address storing unit, transmits inquiry data to the particular wireless network communication control apparatus at predetermined intervals of time; and a reply data receiving unit which receives reply data transmitted from the particular wireless network communication control apparatus that received the inquiry data transmitted by the inquiry data transmitting unit, and which stores in the first classification address storing unit the first classification addresses of the wireless network clients contained in the reply data.

According to a fifth aspect of the present invention, there is provided a network system containing a plurality of wireless network communication control apparatuses which perform connection control of wireless network clients by using first classification addresses thereof, wherein one of the wireless network communication control apparatuses comprises: a first classification address storing unit which stores the first classification addresses of the wireless network clients as its own connection control information; and a notification data broadcast unit which broadcasts notification data at predetermined intervals of time to all terminals connected to a network, the notification data containing the first classification addresses of the wireless network clients retrieved from the first classification address storing unit, and wherein each of the other wireless network communication control apparatuses comprises: a first classification address storing unit which stores the first classification addresses of the wireless network clients as its own connection control information; and a notification data receiving unit which receives the notification data broadcast from the one wireless network communication control apparatus, and which stores in the first classification address storing unit the first classification addresses of the wireless network clients contained in the notification data.

According to the present invention, the connection control information for the wireless network clients can be automatically set in a synchronized manner in the plurality of wireless network communication control apparatuses; to accomplish this, the user need only set the connection control information in only one of the wireless network communication control apparatuses because the same information can then be set automatically in all the other wireless network communication control apparatuses.

### BRIEF DESCRIPTION OF THE DRAWINGS

Other features and advantages of the present invention will be apparent from the following description with reference to the accompanying drawings, in which:

FIG. 1 is a diagram showing one configuration example of a network system to which the present invention is applied;

FIG. 2 is a block diagram showing the configuration of a wireless LAN access point (AP);

FIG. 3 is a flowchart illustrating a processing procedure at a parent access point according to a first embodiment of the present invention;

FIG. 4 is a flowchart illustrating a processing procedure at a child access point according to the first embodiment of the present invention;

FIG. 5 is a diagram showing one example of the data structure of an inquiry packet;

FIG. 6 is a diagram showing one example of the data structure of a reply packet;

FIG. 7 is a diagram showing another example of the data structure of the inquiry packet;

FIG. 8 is a diagram showing another example of the data structure of the reply packet;

FIG. 9 is a flowchart illustrating a processing procedure at the parent access point according to a second embodiment of the present invention; and

FIG. 10 is a flowchart illustrating a processing procedure at the child access point according to the second embodiment of the present invention.

### DESCRIPTION OF THE REFERRED EMBODIMENTS

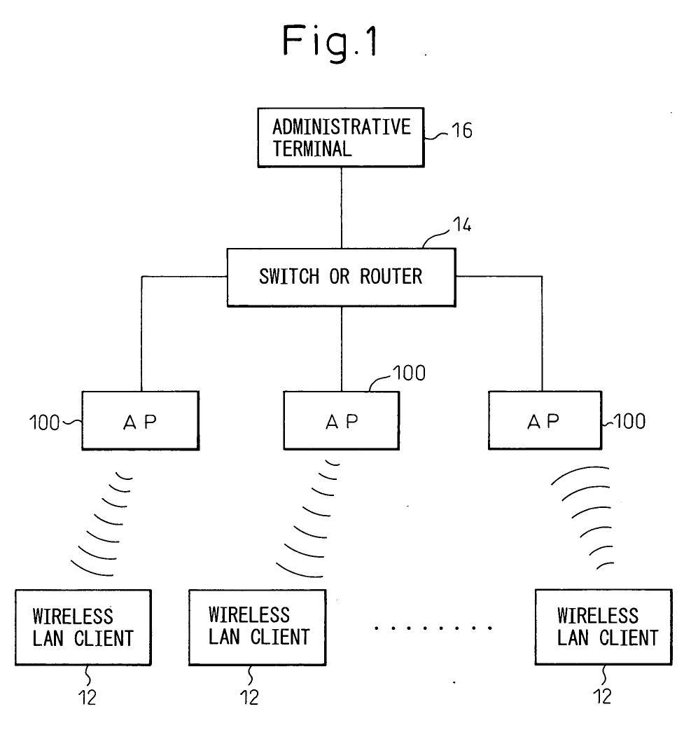

Embodiments of the present invention will be described below with reference to the accompanying drawings. FIG. 1 is a diagram showing a wireless LAN system as one configuration example of a network system to which the present invention is applied. In the figure, each wireless LAN client 12 is connected to the network via one wireless LAN access point (AP) 100 implemented as a wireless network communication control apparatus. The individual wireless LAN access points 100 which are connected to the network via a switch or router 14 are assigned different IP (Internet Protocol) addresses. Here, all the wireless LAN access points 100 need not reside on the same network, but may reside on different networks. The network also contains an administrative terminal (personal computer) 16 for making the settings of the access points 100.

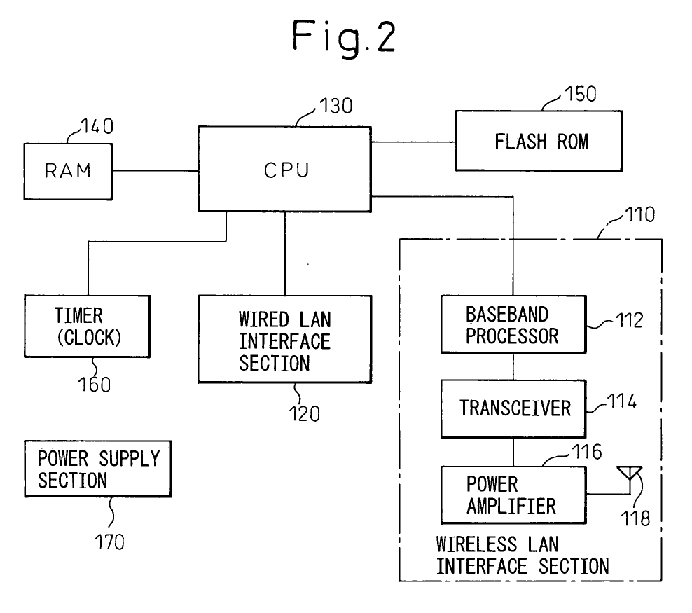

FIG. 2 is a block diagram showing the configuration of each wireless LAN access point (AP) 100. As shown, a wireless LAN access point (AP) 100 comprises: a wireless LAN interface section 110 which converts communication data to radio waves and vice versa for wireless LAN communications; a wired LAN interface section 120 for wired LAN communications; a CPU (Central Processing Unit) 130 which controls the interface sections and also controls data flow; a RAM (Random Access Memory) 140; a flash ROM 150; a timer 160; and a power supply section 170. The wireless LAN interface section 110 comprises a baseband processor 112, a transceiver 114, a power amplifier 116, and an antenna 118.

In a first embodiment of the present invention, the wireless LAN access point, which performs connection control of wireless LAN clients by using their MAC addresses as first classification addresses, periodically accesses another wireless LAN access point via the network by using the IP address, i.e., second classification address, of the latter access point prestored in the former access point, acquires the connection control information already set in that other wireless LAN access point, and stores the thus acquired information as its own connection control information. In this way, the user can make the settings for the plurality of wireless LAN access points in a simple manner.

More specifically, a parent/child relationship is established between the wireless LAN access points. The child access point is a wireless LAN access point that automatically performs the setting of the connection control information for the wireless LAN clients, that is, the MAC address information for the wireless LAN clients whose connections are to be permitted by the wireless LAN access point. The child access point prestores therein the IP address of the parent access point, that is, the wireless LAN access point that the child access point should refer to, and the interval at which the reference should be performed.

Then, the child access point periodically accesses its associated parent access point via the network to acquire the connection control information held in the parent access point, and stores the thus acquired information as its own connection control information. Here, a child access point associated with a certain parent access point can also act as a parent access point for another access point.

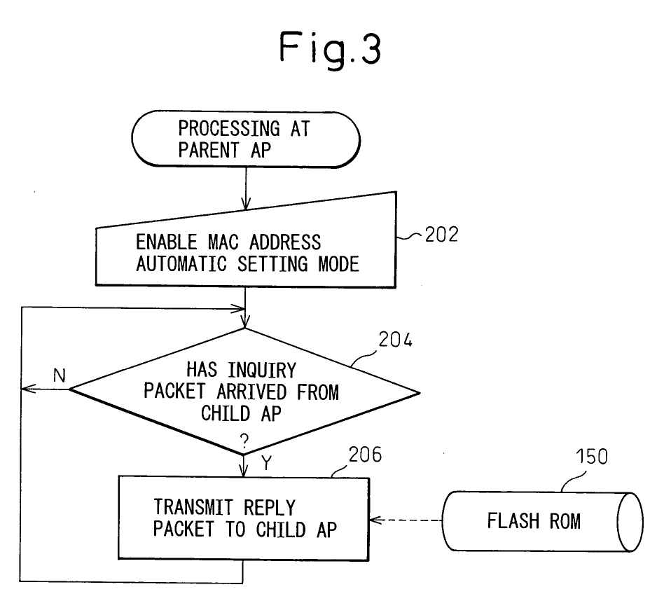

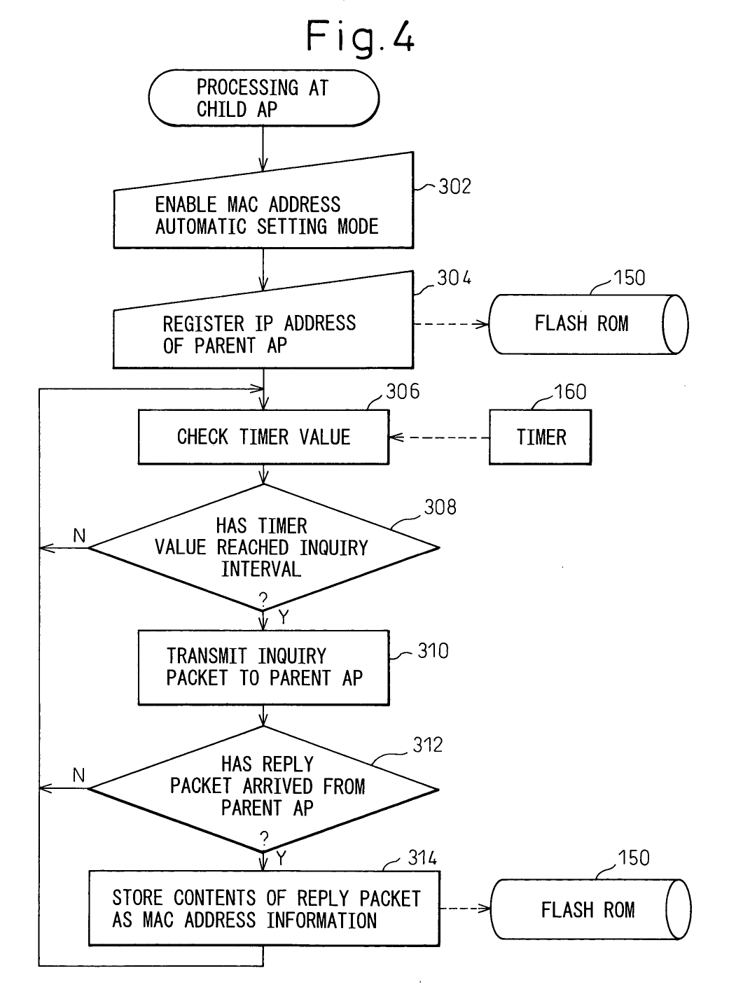

FIG. 3 is a flowchart illustrating a processing procedure at the parent access point, and FIG. 4 is a flowchart illustrating a processing procedure at the child access point. As shown in FIG. 3, in step 202, the parent access point enables MAC address automatic setting mode in response to a user input operation. In the parent access point, wireless LAN clients' MAC addresses are prestored in the flash ROM 150 (FIG. 2) as the connection control information managed therein. Next, in step 204, the parent access point waits for the arrival of an inquiry packet from the child access point.

On the other hand, in step 302 of FIG. 4, the child access point enables MAC address automatic setting mode in response to a user input operation. Next, in step 304, in response to a user input operation, the child access point registers the IP address of the access point that should act as the parent and the inquiry interval with the flash ROM.

Then, in steps 306 and 308, the child access point checks the value of the timer 160 and waits until the timer value reaches the registered inquiry interval. When the inquiry interval is reached, the process proceeds to step 310 where the child access point sends an inquiry packet as inquiry data to the parent access point designated by the registered IP address. Next, in step 312, the child access point checks whether a reply packet, as reply data to the transmitted inquiry packet, has arrived or not; if the reply packet has not arrived yet, the process returns to step 306.

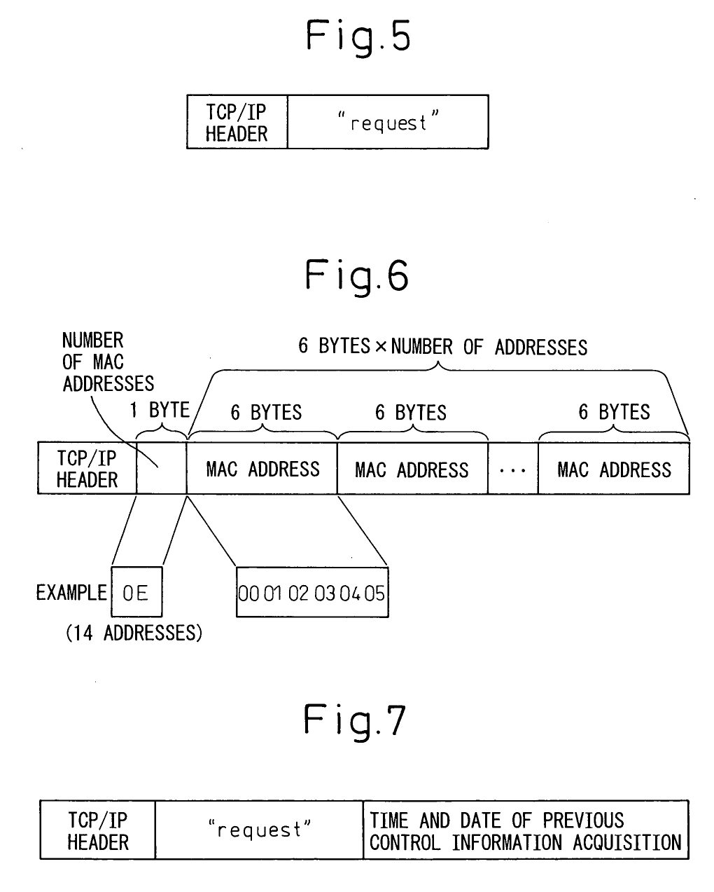

The inquiry packet is a TCP (Transmission Control Protocol) or UDP (User Datagram Protocol) packet, and uses a prescribed port number. An example of the data structure of the inquiry packet is shown in FIG. 5. The inquiry packet carries a TCP/IP header and a specific data sequence by which the receiving node identifies the packet as an inquiry packet. In the example shown, a character string “request” is carried as the inquiry packet identifying data sequence.

In FIG. 3, when the parent access point detects in step 204 that the inquiry packet has arrived from the child access point, the process proceeds to step 206. In step 206, the parent access point creates a reply packet based on the wireless LAN clients' MAC addresses stored in the flash ROM as the connection control information managed therein, and transmits the packet to the inquiring child access point. The process then returns to step 204.

The reply packet, like the inquiry packet, is a TCP or UDP packet, and uses a prescribed port number. An example of the data structure of the reply packet is shown in FIG. 6. As shown, the reply packet carries as data the MAC addresses of the wireless LAN clients whose connections are to be permitted and the number of the MAC addresses carried therein. Specifically, in the example shown here, of the data contained in the reply packet, one byte is used to represent the number of MAC addresses in hexadecimal, which is followed by a sequence of MAC addresses each represented by 6 bytes in hexadecimal.

On the other hand, in FIG. 4, when the child access point detects in step 312 that the reply packet has arrived from the parent access point, the process proceeds to step 314. In step 314, the child access point stores the MAC addresses carried in the reply packet into the flash ROM as its own wireless LAN client connection control information. The process then returns to step 306.

In the case of a wireless LAN access point that acts as a parent access point as well as a child access point, the processing of FIG. 3 and the processing of FIG. 4 are performed in parallel fashion. In this way, the connection control information can be set in all the wireless LAN access points, by just requiring the user to set the connection control information in at least one wireless LAN access point and to set the IP address of the parent wireless LAN access point in the other wireless LAN access points.

In the above embodiment, the connection control information for the wireless LAN clients can be set in a synchronized manner in every child access point by receiving the setting information from its parent access point. However, if all the control information is to be transferred each time an inquiry is made from the child access point, apparatus load and network traffic may increase.

In view of this, the inquiry packet to be transmitted from the child access point may be created by including therein the time and date of the previous control information acquisition, as shown in FIG. 7, with provisions made so that, when the inquiry packet is received, the parent access point compares the time and date carried in the packet with the last update time and date of the control information managed in the parent access point, and does not transmit a reply packet if the control information has not been updated since the time and date of the previous control information acquisition.

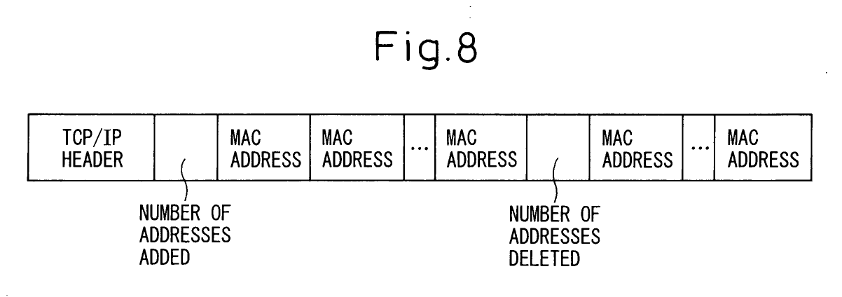

Further, provisions may be made so that, when the inquiry packet shown in FIG. 7 is received, the parent access point compares the time and date carried in the packet with the last update time and date of the control information managed in the parent access point, and transmits to the child access point only the MAC addresses that have been added or deleted since the time and date of the previous control information acquisition. An example of the reply packet in this case is shown in FIG. 8. In the example shown, the added addresses and the number of added addresses, and the deleted addresses and the number of deleted addresses, are carried in the reply packet for transmission to the child access point. The child access point updates its own control information based on the contents of the received reply packet.

Next, a second embodiment of the present invention will be described. In the foregoing embodiment, the child access point issues an inquiry packet at predetermined intervals of time, in the present embodiment the parent access point transmits a notification packet as notification data to the child access point at predetermined intervals of time, and the child access point that received the notification packet sets the data as its own connection control information. In the present embodiment also, the settings for the plurality of wireless LAN access points can be accomplished in a simple manner.

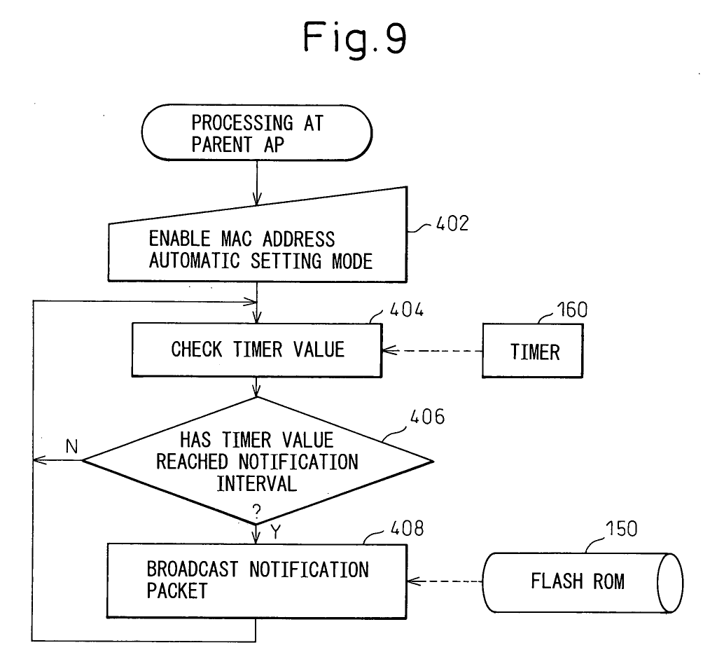

FIG. 9 is a flowchart illustrating a processing procedure at the parent access point according to the second embodiment. In step 402, the parent access point enables MAC address automatic setting mode in response to a user input operation. In the parent access point, wireless LAN clients' MAC addresses are prestored in the flash ROM 150 (FIG. 2) as the connection control information managed therein.

Next, in steps 406 and 408, the parent access point checks the value of the timer 160 and waits until the timer value reaches the predetermined notification interval. When the notification interval is reached, the process proceeds to step 408 where the parent access point broadcasts the notification packet to all the terminals within the area. Here, the term “broadcast” means transmitting the same message simultaneously to all the terminals within the network area. The contents of the notification packet are the same as those of the reply packet previously shown in FIG. 6. After carrying out step 408, the process returns to step 404.

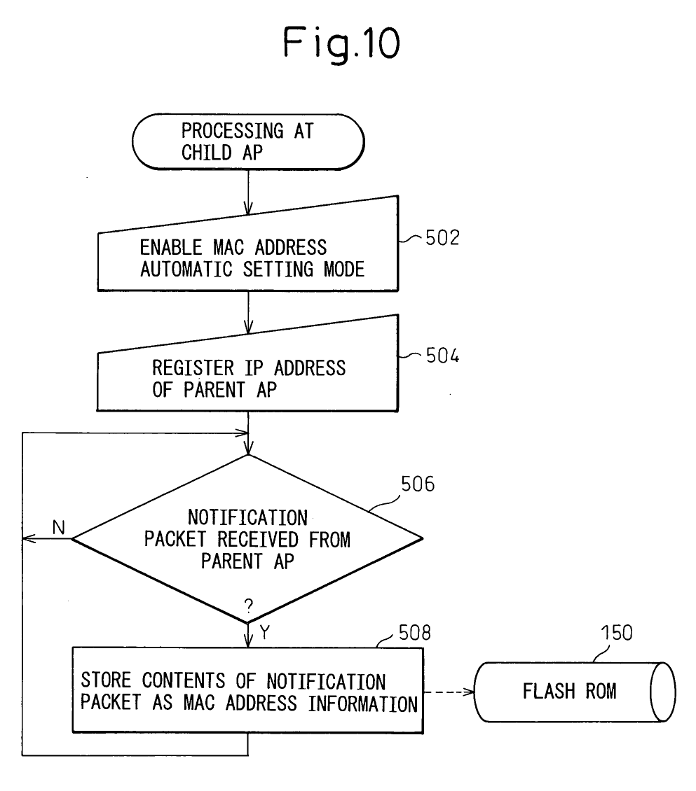

The processing procedure performed at the child access point according to the second embodiment is shown in the flowchart of FIG. 10. In step 502, the child access point enables MAC address automatic setting mode in response to a user input operation. Next, in step 504, in response to a user input operation, the child access point registers the IP address of the access point that should act as the parent with the flash ROM.

Next, in step 506, the child access point waits for the arrival of the notification packet from the parent access point designated by the thus registered IP address. When the child access point detects that the notification packet from the parent access point has arrived, the process proceeds to step 508. In step 508, the child access point stores the MAC addresses carried in the notification packet into the flash ROM as its own wireless LAN client connection control information. The process then returns to step 506.

In the second embodiment also, to prevent increases in apparatus load and network traffic, all the control information may be broadcast at first and, thereafter, only updated information may be broadcast, as in the case described with reference to FIG. 8.

The invention may be embodied in other specific forms without departing from the spirit or essential characteristics thereof. The present embodiment is therefore to be considered in all respects as illustrative and not restrictive, the scope of the invention being indicated by the appended claims rather than by the foregoing description and all changes which come within the meaning and range of equivalency of the claims are therefore intended to be embraced therein.

What is claimed is:

1. A network system containing a plurality of wireless network communication control apparatuses which perform connection control of wireless network clients by using first classification addresses thereof, wherein
at least one of said wireless network communication control apparatuses comprises:
a first classification address storing unit which stores the first classification addresses of said wireless network clients as its own connection control information;
an inquiry data receiving unit which receives inquiry data transmitted from another one of said wireless network communication control apparatuses connected via a network; and
a reply data transmitting unit which transmits reply data containing the first classification addresses of said wireless network clients retrieved from said first classification address storing unit, to said other wireless network communication control apparatus in response to said inquiry data received by said inquiry data receiving unit, and wherein
said other wireless network communication control apparatus comprises:
a first classification address storing unit which stores the first classification addresses of said wireless network clients as its own connection control information;
a second classification address storing unit which stores the second classification address of a particular one of said wireless network communication control apparatuses connected via said network;
an inquiry data transmitting unit which, based on said second classification address stored in said second classification address storing unit, transmits said inquiry data to said particular wireless network communication control apparatus at predetermined intervals of time; and
a reply data receiving unit which receives said reply data transmitted from said particular wireless network communication control apparatus that received said inquiry data transmitted by said inquiry data transmitting unit, and which stores, in said first classification address storing unit, the first classification addresses of said wireless network clients contained in said reply data.

2. A network system as claimed in claim 1, wherein said inquiry data transmitting unit transmits said inquiry data by including therein information indicating the time and date of reception of previous reply data, and wherein said reply data transmitting unit compares said information contained in said inquiry data with the last update time and date of said connection control information managed therein, and does not transmit said reply data if said connection control information managed therein has not been updated since the time and date of reception of said previous reply data.

3. A network system as claimed in claim 1, wherein said inquiry data transmitting unit transmits said inquiry data by including therein information indicating the time and date of reception of previous reply data, and wherein said reply data transmitting unit compares said information contained in said inquiry data with the last update time and date of said connection control information managed therein, and transmits only connection control information items that have been updated since the time and date of reception of said previous reply data.

4. A wireless network communication control apparatus which performs connection control of wireless network clients by using first classification addresses thereof, comprising:
a first classification address storing unit which stores the first classification addresses of said wireless network clients as its own connection control information;
an inquiry data receiving unit which receives inquiry data transmitted from another wireless network communication control apparatus connected via a network;
a reply data transmitting unit which transmits reply data containing the first classification addresses of said wireless network clients retrieved from said first classification address storing unit, to said other wireless network communication control apparatus in response to said inquiry data received by said inquiry data receiving unit;
a second classification address storing unit which stores the second classification address of a particular wireless network communication control apparatus connected via said network;
an inquiry data transmitting unit which, based on said second classification address stored in said second classification address storing unit, transmits inquiry data to said particular wireless network communication control apparatus at predetermined intervals of time; and
a reply data receiving unit which receives reply data transmitted from said particular wireless network communication control apparatus that received said inquiry data transmitted by said inquiry data transmitting unit, and which stores in said first classification address storing unit the first classification addresses of said wireless network clients contained in said reply data.

5. A wireless network communication control apparatus as claimed in claim 4, wherein said inquiry data transmitting unit transmits said inquiry data by including therein information indicating the time and date of reception of previous reply data, and wherein said reply data transmitting unit compares said information contained in said inquiry data with the last update time and date of said connection control information managed therein, and does not transmit said reply data if said connection control information managed therein has not been updated since the time and date of reception of said previous reply data.

6. A wireless network communication control apparatus as claimed in claim 4, wherein said inquiry data transmitting unit transmits said inquiry data by including therein information indicating the time and date of reception of previous reply data, and wherein said reply data transmitting unit compares said information contained in said inquiry data with the last update time and date of said connection control information managed therein, and transmits only connection control information items that have been updated since the time and date of reception of said previous reply data.

7. A wireless network communication control apparatus which performs connection control of wireless network clients by using first classification addresses thereof, comprising:
a first classification address storing unit which stores the first classification addresses of said wireless network clients as its own connection control information;
an inquiry data receiving unit which receives inquiry data transmitted from another wireless network communication control apparatus connected via a network; and
a reply data transmitting unit which transmits reply data containing the first classification addresses of said wireless network clients retrieved from said first classification address storing unit, to said other wireless network communication control apparatus in response to said inquiry data received by said inquiry data receiving unit.

8. A wireless network communication control apparatus which performs connection control of wireless network clients by using first classification addresses thereof, comprising:
a first classification address storing unit which stores the first classification addresses of said wireless network clients as its own connection control information;
a second classification address storing unit which stores the second classification address of a particular wireless network communication control apparatus connected via a network;
an inquiry data transmitting unit which, based on said second classification address stored in said second classification address storing unit, transmits inquiry data to said particular wireless network communication control apparatus at predetermined intervals of time; and
a reply data receiving unit which receives reply data transmitted from said particular wireless network communication control apparatus that received said inquiry data transmitted by said inquiry data transmitting unit, and which stores in said first classification address storing unit the first classification addresses of said wireless network clients contained in said reply data.

9. In a network system containing a plurality of wireless network communication control apparatuses which perform connection control of wireless network clients by using first classification addresses thereof, a method for setting up connection control information in said wireless network communication control apparatuses, wherein
at least one of said wireless network communication control apparatuses carries out:
(a) receiving inquiry data transmitted from another one of said wireless network communication control apparatuses connected via a network; and
(b) transmitting reply data to said other wireless network communication control apparatus in response to said inquiry data received in (a), said reply data containing the first classification addresses retrieved from a first classification address storing unit in which the first classification addresses of said wireless network clients are stored as its own connection control information, and
said other wireless network communication control apparatus carries out:
(c) transmitting said inquiry data to a particular one of said wireless network communication control apparatuses connected via said network, based on a second classification address stored in a second classification address storing unit which stores the second classification address of said particular wireless network communication control apparatus; and
(d) receiving said reply data transmitted from said particular wireless network communication control apparatus that received said inquiry data transmitted in (c), and storing the first classification addresses of said wireless network clients contained in said reply data into a first classification address storing unit which stores the first classification addresses of said wireless network clients as its own connection control information.

10. A network system containing a plurality of wireless network communication control apparatuses which perform connection control of wireless network clients by using first classification addresses thereof, wherein
one of said wireless network communication control apparatuses comprises:
a first classification address storing unit which stores the first classification addresses of said wireless network clients as its own connection control information; and
a notification data broadcast unit which broadcasts notification data at predetermined intervals of time to all terminals connected to a network, said notification data containing the first classification addresses of said wireless network clients retrieved from said first classification address storing unit, and wherein
each of the other wireless network communication control apparatuses comprises:
a first classification address storing unit which stores the first classification addresses of said wireless network clients as its own connection control information; and
a notification data receiving unit which receives said notification data broadcast from said one wireless network communication control apparatus, and which stores in said first classification address storing unit the first classification addresses of said wireless network clients contained in said notification data.

11. A wireless network communication control apparatus which performs connection control of wireless network clients by using first classification addresses thereof, comprising:
a first classification address storing unit which stores the first classification addresses of said wireless network clients as its own connection control information; and
a notification data broadcast unit which broadcasts notification data at predetermined intervals of time to all terminals connected to a network, said notification data containing the first classification addresses of said wireless network clients retrieved from said first classification address storing unit.

12. A wireless network communication control apparatus which performs connection control of wireless network clients by using first classification addresses thereof, comprising:
a first classification address storing unit which stores the first classification addresses of said wireless network clients as its own connection control information; and
a notification data receiving unit which receives notification data broadcast from another wireless network communication control apparatus, and which stores in said first classification address storing unit the first classification addresses of said wireless network clients contained in said notification data.

13. In a network system containing a plurality of wireless network communication control apparatuses which perform connection control of wireless network clients by using first classification addresses thereof, a method for setting up connection control information in said wireless network communication control apparatuses, wherein
one of said wireless network communication control apparatuses carries out:
broadcasting notification data at predetermined intervals of time to all terminals connected to a network, said notification data containing the first classification addresses of said wireless network clients retrieved from a first classification address storing unit in which the first classification addresses of said wireless network clients are stored as its own connection control information, and
each of the other wireless network communication control apparatuses carries out:
receiving said notification data broadcast from said one wireless network communication control apparatus, and storing the first classification addresses of said wireless network clients contained in said notification data into a first classification address storing unit which stores the first classification addresses of said wireless network clients as its own connection control information.

14. A program executable on a wireless network communication control apparatus that performs connection control of wireless network clients by using first classification addresses thereof, wherein said program causes said wireless network communication control apparatus to implement the functions of:
a first classification address storing unit which stores the first classification addresses of said wireless network clients as its own connection control information;
an inquiry data receiving unit which receives inquiry data transmitted from another wireless network communication control apparatus connected via a network;
a reply data transmitting unit which transmits reply data containing the first classification addresses of said wireless network clients retrieved from said first classification address storing unit, to said other wireless network communication control apparatus in response to said inquiry data received by said inquiry data receiving unit;
a second classification address storing unit which stores the second classification address of a particular wireless network communication control apparatus connected via said network;
an inquiry data transmitting unit which, based on said second classification address stored in said second classification address storing unit, transmits inquiry data to said particular wireless network communication control apparatus at predetermined intervals of time; and
a reply data receiving unit which receives reply data transmitted from said particular wireless network communication control apparatus that received said inquiry data transmitted by said inquiry data transmitting unit, and which stores in said first classification address storing unit the first classification addresses of said wireless network clients contained in said reply data.
